(19) United States
(12) Patent Application Publication
(10) Pub. No.: US 2005/0126013 A1
(43) Pub. Date: Jun. 16, 2005

(54) CHILD'S SCISSORS WITH SIMULATED VEHICLE ATTACHMENT

(76) Inventors: Kathleen A. Vastano, Millville, NJ (US); Angelo J. Vastano III, Millville, NJ (US)

Correspondence Address: LITMAN LAW OFFICES, LTD, PO BOX 15035, CRYSTAL CITY STATION, ARLINGTON, VA, 22215, US

(21) Appl. No.: 10/732,478

(22) Filed: Dec. 11, 2003

(51) Int. Cl. B26B 13/00

(52) U.S. Cl. 30/233; 30/254

(57) ABSTRACT

The child's scissors with simulated vehicle attachment is a pair of child's scissors that has a simulated car or other forward-moving vehicle extending vertically from the upper cutting blade. The simulated vehicle is designed to instruct a child in the use of scissors by suggesting that the scissors are fun and non-threatening. Additionally, the simulated vehicle intimates to a child that forward movement of the scissors is necessary for proper use, and encourages the child to cut in a straight line by “driving the vehicle” across the page being cut. The simulated vehicle also helps a child hold the scissors correctly by providing a visual marker that should be positioned on top of the scissors when held properly.

### BACKGROUND OF THE INVENTION

1. Field of the Invention

The present invention relates to scissors and, more particularly, to a pair of child's scissors designed to take advantage of contemporary theories and practices in the field of early childhood development by incorporating an element of play into learning to properly use a pair of scissors.

2. Description of the Related Art

The use of scissors is an essential skill that is typically learned in preschool and first grade. In addition to promoting fine motor coordination, it is necessary to complete many of the activities associated with preschool and first grade, such as art projects where pieces of paper are sectioned, rearranged and glued together. Yet, for many young children the use of scissors can be intimidating and difficult. Some children are confused as to which grip loop is for the thumb and which is for the fingers. Others are unable to focus when attempting to cut in a straight line, and some have difficulty understanding that the scissors must be moved forward into the paper being cut. Consequently, to many children, the use of scissors is a task viewed as work rather than play.

Contemporary theories and practices in the field of early childhood development, such as those derived from the works of Jean Piaget and Jerome Bruner, suggest that “play is a child's work” and that children acquire new skills and knowledge more readily when those skills and knowledge build on previous experiences. Specifically, the doctrines of Constructivism and Assimilation hold that children assimilate new skills and knowledge by reflecting on their past experiences to “construct” new understandings. Accordingly, children will grasp a new skill more readily when learning the skill is associated with a past play experience or with a toy with which the child is familiar. Therefore, as applied to learning to use a pair of scissors, contemporary theories and practices suggest that scissors having an attachment resembling a toy with which children are familiar would be beneficial.

U.S. Design Pat. No. 301,348, issued May 30, 1989 to W. L. Li et al., shows a pair of toy scissors with the blades formed to resemble the head of an elephant. U.S. Design Pat. No. 367,415, issued Feb. 27, 1996 to Y. S. Wu. shows a pair of child scissors shaped to resemble a reptile.

U.S. Design Pat. No. 303,919, issued Oct. 10, 1989 to L. Pate, and U.S. Design Pat. No. 407,527, issued Mar. 30, 1999 to E. Bellisario, shows combinations of a pair of scissors and a comb for use by a hairstylist.

U.S. Design Pat. No. 399,971, issued Oct. 20, 1998 to R. C. Scherer, shows a pair of surgical scissors with a shield to protect its user from a spray of blood. U.S. Pat. No. 2,557,553, issued Jun. 19, 1951 to M. I. Metzger, teaches a pair of play scissors with a safety guard.

U.S. Pat. No. 2,591,740, issued Apr. 8, 1952 to W. M. Stilwell et al., teaches a pair of child's safety scissors that incorporates a narrow slot into which a sheet of paper is positioned for cutting.

None of the above inventions and patents, taken either singly or in combination, is seen to describe the instant invention as claimed. Thus, a pair of child's scissors with a simulated vehicle attachment solving the aforementioned problems is desired.

### SUMMARY OF THE INVENTION

The child's scissors with simulated vehicle attachment is a pair of child's scissors that has a simulated car or other forward-moving vehicle extending vertically from the upper cutting blade. The vehicle attachment is designed to instruct a child in the use of scissors by suggesting that the scissors are fun and non-threatening. Additionally, the vehicle attachment intimates to a child that forward movement of the scissors is necessary for proper use, and encourages the child to cut in a straight line by “driving the vehicle” across the page being cut. The vehicle attachment also helps a child hold the scissors correctly by providing a visual marker that should be positioned on top of the scissors when held properly.

Accordingly, it is a principal object of the invention to provide a pair of child scissors that invites children to engage in the use of scissors.

It is another object of the invention to provide a pair of child scissors that helps a child hold the scissors correctly.

It is a further object of the invention to provide a pair of child scissors that intimates to a child that forward movement of the scissors is necessary for proper use.

Still another object of the invention is to provide a pair of child's scissors that encourages a child to cut in a straight line.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a child's scissors with vehicle attachment according to the present invention.

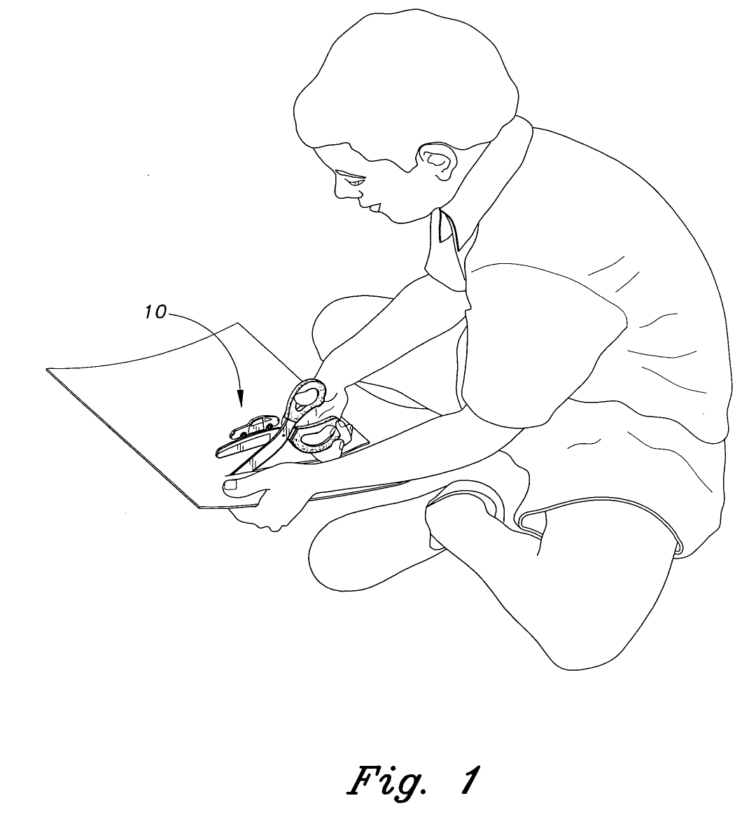

FIG. 2 is a perspective view of a child's scissors with vehicle attachment according to the present invention.

FIG. 3 is an exploded view of the child's scissors of FIG. 2.

FIG. 4 is a perspective view of an alternative embodiment of a child's scissors with vehicle attachment according to the present invention.

FIG. 5 shows a simulated vehicle adapted for attachment to a pair of child's scissors according to the present invention.

Similar reference characters denote corresponding features consistently throughout the attached drawings.

### DETAILED DESCRIPTION OF THE PREFERRED EMBODIMENTS

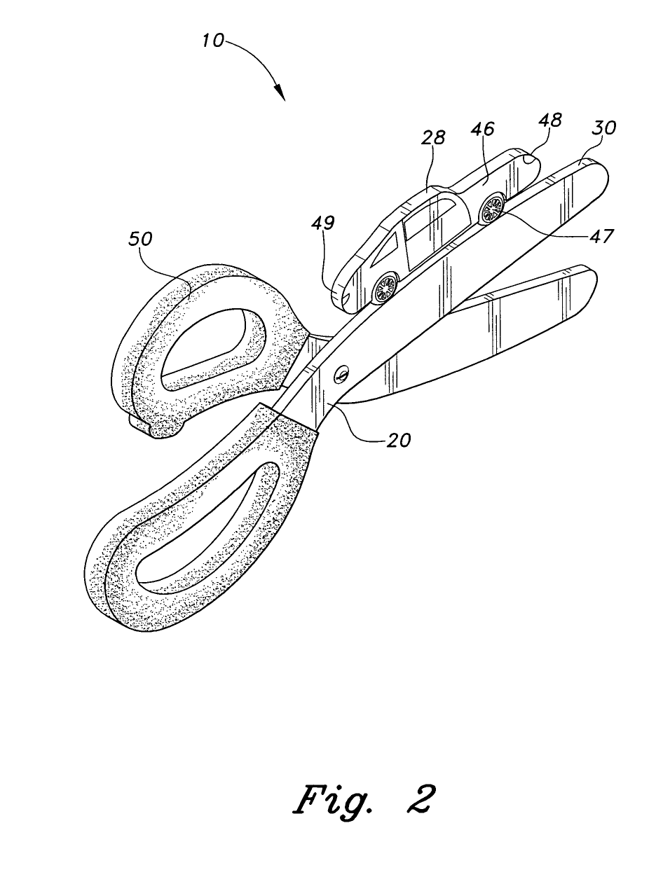

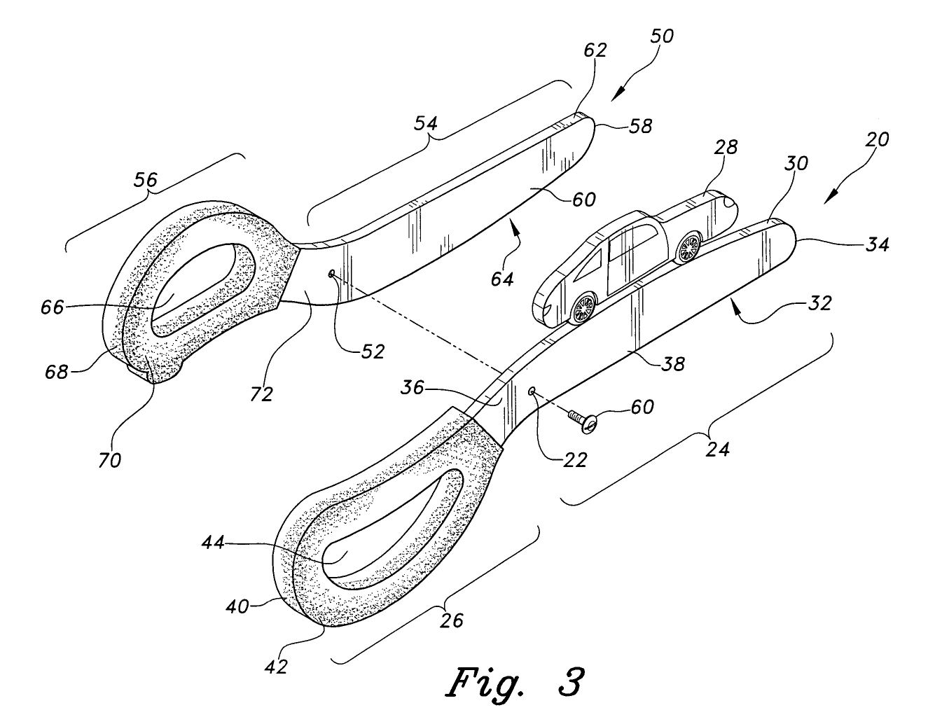

The present invention is a pair of child's scissors with a vehicle attachment, designated generally as 10 in the drawings. As shown in FIGS. 2 and 3, the scissors 10 include a top member 20 and a bottom member 50 pivotally coupled together by a screw 60 that passes through a non-threaded aperture 22 in the top member 20 and engages with a threaded aperture 52 in the bottom member 50.

The top member 20 is constructed of a piece of metal formed into an elongated blade portion 24, a finger grip portion 26 and a simulated vehicle 28. The elongated portion 24 is substantially flat with a proximal end 36, a distal end 34, an outside surface 38, an inside surface opposite the outside surface 38, a top surface 30 and a bottom surface 32 opposite the top surface 30. Each of the top and bottom surfaces 30 and 32 extends from the proximal end 36 to the distal end 34 and has an inner edge and an outer edge. The outer edge of the bottom surface 32 and the inner and outer edges of top surface 30 are rounded and dull. The inner edge of the bottom surface 32 is squared and sharp, and functions as the cutting edge of the elongated portion 24.

The finger grip portion 26 of the top member 20 forms an elongated loop 44 adapted to receive the fingers of a child's hand, and has a proximal end 36, a distal end 40 and a fitted plastic covering 42 to protect the fingers of a child using the scissors 10. The proximal ends 36 of the finger grip portion 26 and the elongated portion 24 are contiguous.

The simulated vehicle 28 is substantially flat with a left side, a right side 46, a forward end 48 and a rear end 49. From either of its sides, the simulated vehicle 28 resembles the profile of an automobile. The simulated vehicle 28 extends from the elongated portion 24 with the wheels 47 being contiguous with the top surface 30 of the elongated portion 24, and with its forward end 48 oriented toward the distal end 34 of the elongated portion 24. The simulated vehicle 28 may be made in one piece with the top blade 24 by casting, forging, or other metal forming processes, or made separately and attached to the blade 20 by adhesive, welding, or other joinery processes.

The bottom member 50 is constructed of a piece of metal formed into an elongated blade portion 54 and a thumb grip portion 56. The elongated portion 54 is substantially flat with a proximal end 72, a distal end 58, an inside surface 60, an outside surface opposite the inside surface 60, a top surface 62 and a bottom surface 64 opposite the top surface 62. Each of the top and bottom surfaces 62 and 64 extends from the proximal end 72 to the distal end 58 and has an inner edge and an outer edge. The outer edge of the top surface 62 and the inner and outer edges of bottom surface 64 are rounded and dull. The inner edge of the bottom surface 64 is squared and sharp, and functions as the cutting edge of this elongated blade portion 54.

The thumb grip portion 56 of the bottom member 50 forms an elongated loop 66 adapted to receive a child's thumb, and has a proximal end 72, a distal end 68 and a fitted plastic covering 70 to protect the child's thumb. The proximal ends 72 of the thumb grip portion 56 and the elongated portion 54 are contiguous.

Each of the top member 20 and the bottom member 50 is between one-sixteenth and one-eighth of an inch in thickness. The top and bottom members 20 and 50 are pivotally coupled such that when the thumb grip portion 56 and finger grip portion 26 are moved together, apart and back together, the cutting edges of the two elongated blade portions 24 and 54 scrape past each other and thereby cut any paper between the two blades 24 and 54. Thus, a child would operate the invention 10 by inserting his or her thumb into the thumb grip portion 56 and fingers into finger grip portion 26 and moving his or her thumb and fingers together, apart and back together.

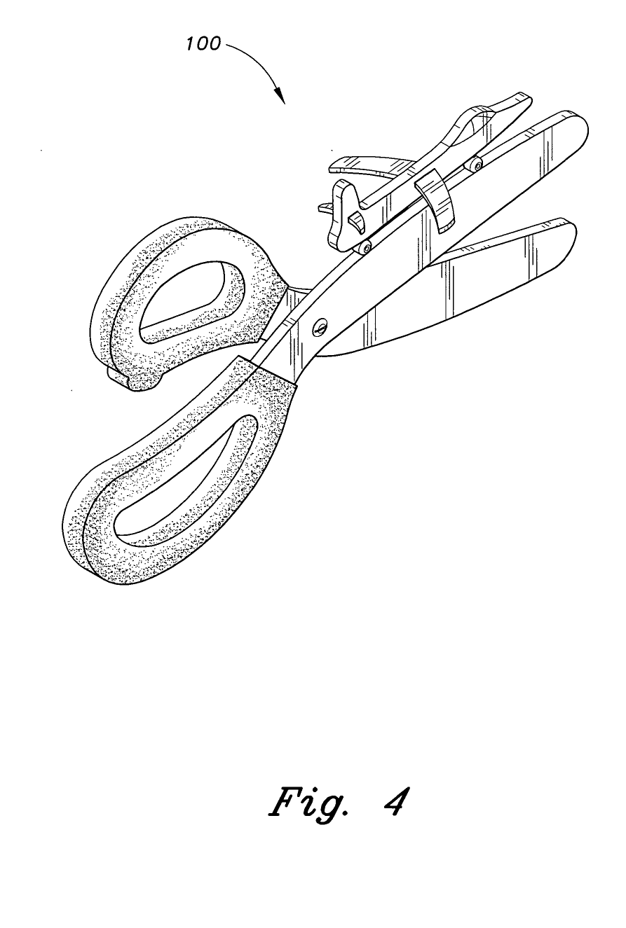

As shown in FIG. 4, the invention 100 can be altered by simply varying the type of vehicle used as the simulated vehicle. In FIG. 4, the simulated vehicle extending from the elongated portion of the top member simulates an airplane instead of an automobile. Furthermore, although not shown, the simulated vehicle could be any vehicle capable of forward motion including, but not limited to, a truck, a boat, a skateboard, a roller skate, a scooter, a motorcycle, a bicycle, a snowmobile, a stroller, a shopping cart, a wagon, a doll carriage, a wave runner, a sled, a sleigh, a horse drawn carriage, a train or a go-cart.

In other embodiments, the top and bottom members could be constructed of a combination of molded plastic and metal or could be pivotally coupled by a nut and bolt assembly or a bolt and cod pin assembly.

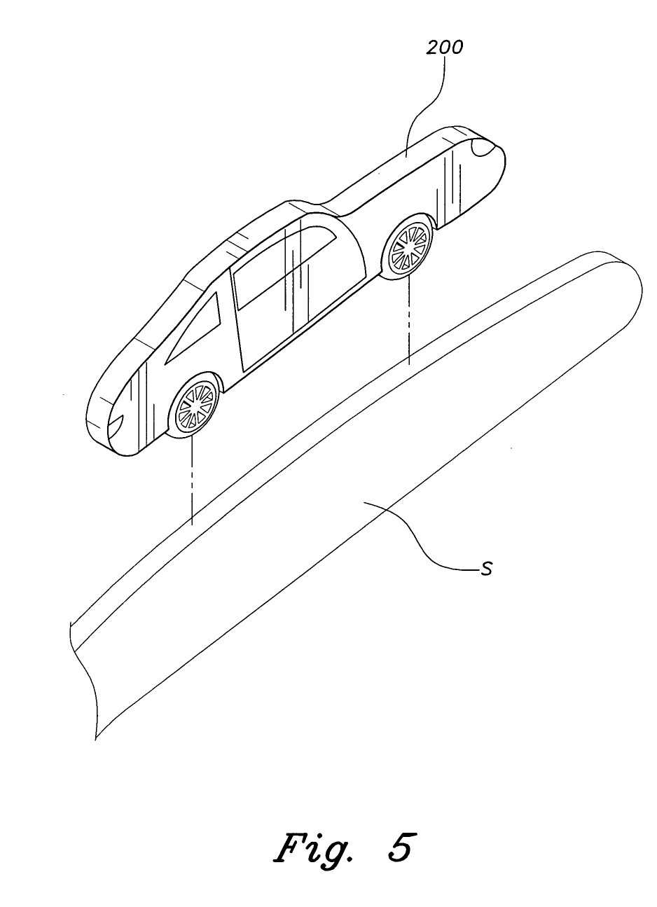

As shown in FIG. 5, the present invention may also be realized by providing a simulated vehicle 200 that can be provided as an aftermarket attachment to a blade of a pair of child's scissors S, the simulated vehicle 200 being joined to the scissors by adhesive, welding, or other joinery methods.

It is to be understood that the present invention is not limited to the embodiments described above, but encompasses any and all embodiments within the scope of the following claims.

1. A pair of child's play scissors with simulated vehicle attachment, comprising:
a top member having a finger grip portion and a first elongated blade portion extending from the finger grip portion, the elongated blade portion having a cutting edge, the elongated blade portion being substantially planar and having a proximal end proximal to the finger grip portion, a distal end, an outside surface, an inside surface, and a top surface, the top surface extending from the proximal end to the distal end;
a simulated vehicle attached to and extending from the top surface of the first elongated blade portion, the simulated vehicle having a forward end and a back end, the forward end pointing toward the distal end of said first elongated blade portion, whereby the simulated vehicle indicates an upright position and a forward direction for operation of the scissors;
a bottom member having a thumb grip portion and a second elongated blade portion extending from the thumb grip portion, the second elongated blade portion having a second cutting edge; and
means for pivotally coupling said top member and said bottom member;
whereby when said thumb grip portion and said finger grip portion are moved together, apart and back together, the cutting edges of the elongated blade portions scrape past each other and thereby cut any paper between the two elongated blade portions.

2. The pair of child's play scissors according to claim 1, wherein:
said simulated vehicle is selected from the group of simulated forward moving vehicles consisting of a car, a truck, an airplane, a boat, a skateboard, a roller skate, a scooter, a motorcycle, a bicycle, a snowmobile, a stroller, a shopping cart, a wagon, a doll carriage, a wave runner, a sled, a sleigh, a horse drawn carriage, a train and a go-cart.

3. (canceled)

4. (canceled)

5. (canceled)
